(19) United States
(12) Patent Application Publication
(10) Pub. No.: US 2001/0022567 A1
(43) Pub. Date: Sep. 20, 2001

(54) DISPLAY DEVICE

(76) Inventor: KAREL E. KUIJK, EINDHOVEN (NL)

Correspondence Address: CORPORATE PATENT COUNSEL, U S PHILIPS CORP, 580 WHITE PLAINS ROAD, TARRYTOWN, NY, 10591

(21) Appl. No.: 09/137,282

(22) Filed: Aug. 20, 1998

(30) Foreign Application Priority Data
Aug. 26, 1997 (EP) 97202614.0

(51) Int. Cl. G09G 3/36

(52) U.S. Cl. 345/87; 345/100

(57) ABSTRACT

Passive display driven by means of multiple-row addressing, in which the drive voltages are decreased by an optimum choice of the number of orthogonal signals.

The invention relates to a display device comprising a liquid crystal material between a first substrate provided with row or selection electrodes and a second substrate provided with column or data electrodes, in which overlapping parts of the row and column electrodes define pixels, drive means for driving the column electrodes in conformity with an image to be displayed, and drive means for driving the row electrodes. Such display devices are used in, for example portable apparatuses such as laptop computers, notebook computers and telephones.

Passive matrix displays of this type are generally known and, to be able to realize driving of a large number of rows, they are more and more based on the (S)TN ((Super)-Twisted Nematic)) effect.

In (S)TN liquid crystal display devices, the pixels react to the effective value (rms value) of the supplied voltage. The drive of liquids (pixels) reacting in this manner is described in Alt & Pleshko's article “Scanning Limitations of Liquid Crystal Displays”, IEEE Trans. on El. Dev., Vol. ED 21, No. 2, February 1974, pp. 146-155.

In these devices, one row is consecutively driven each time. When rapidly switching (S)TN liquid crystal material is used, there is relaxation of the directors within one frame period. This leads to loss of contrast and is sometimes also referred to as “frame response”.

Notably in applications in display devices built into portable apparatuses (mobile telephone, laptop computers) the aim is to drive these apparatuses with a minimal energy. It is notably attempted to minimize the drive voltages as much as possible in these cases.

It is an object of the invention to provide a display device of the type described above in which a drive voltage which is chosen to be as favorable as possible is sufficient.

Moreover, the invention aims at a maximal “frame response” reduction.

To this end, a display device according to the invention is characterized in that the multiplexibility m of the liquid crystal material is larger than or equal to the number of row electrodes N, and that the drive means for driving the row electrodes in the operating state sequentially provide groups of p electrodes with p mutually orthogonal signals, the value of p of the number of rows driven simultaneously being an integer which is chosen to be as proximate as possible to the optimum value pₒₚₜ=\sqrt{m_{eff}}±\sqrt{(m_{eff}−N)}, in which N<m_{eff}<m.

In this application, the multiplexibility of the liquid crystal material m is understood to mean the maximum number of rows which can be driven with a maximum contrast by means of the relevant liquid crystal material, which is determined by the so-called Alt & Pleshko maximum, as described in the above-mentioned article.

The invention is based on the recognition that, when driving p rows simultaneously, the drive voltage of the rows and the maximal drive voltages of the columns can be chosen to be substantially equal to each other. Notably in drive-ICs, which supply row voltages as well as column voltages, this leads to lower power supply voltages.

Preferably, pₒₚₜ=\sqrt{m}−\sqrt{(m−N)}. This yields equal row voltages and (maximally possible) column voltages and leads to the lowest supply voltage for a drive IC where the supply voltage is determined by the highest of the two voltages.

A power of two is preferably chosen for p, which is as proximate as possible to pₒₚₜ because a set of orthogonal signals consists of a number of functions which is a power of two, and each function of this set further consists of a number of elementary pulses which is the same power of two. If fewer functions for driving are chosen than are present in the set of orthogonal functions, the elementary period of time of the pulses decreases proportionally, which is unfavorable for RC time effects across the columns and rows. Since Pₒₚₜ is not always a power of two, the voltages for the orthogonal signals are not always equal to each other. The mutual deviation remains limited to about 38%.

It is to be noted that an article by T. J. Scheffer and B. Clifton “Active Addressing Method for High-Contrast Video-Rate STN Displays”, SID Digest 92, pp. 228-231, describes how “frame response” is avoided by making use of “Active Addressing”, in which all rows are driven during the entire field period with mutually orthogonal signals, for example Walsh functions. The result is that each pixel is continuously excited by pulses (in an STN LCD of 240 rows, 256 times per field period) instead of once per field period.

In an article by T. N. Ruckmongathan et al. “A New Addressing Technique for Fast Responding STN LCDs”, Japan Display 92, pp. 65-68, a group of L rows is driven with mutually orthogonal signals. Since a set of orthogonal signals, such as Walsh functions, consists of a number of functions which is a power of 2, hence 2^{S}, L is preferably chosen to be as equal as possible thereto, hence generally L=2^{S}, or L=2^{S}−1. The orthogonal row signals Fᵢ(t) are preferably square-shaped and consist of the voltages +F and −F, while the row voltage is equal to zero outside the selection period. The elementary voltage pulses of which the orthogonal signals are composed, are regularly distributed in the field period. Thus, the pixels are then excited 2^{S} or (2^{S}−1) times per field period with regular intervals instead of once per field period. Even for low values of L, such as L=3 or L=7, it appears that the “frame response” is suppressed just as well as the driving of all rows simultaneously, as in “Active Addressing”, but much less electronic hardware is required for this purpose. However, neither of the two articles states how drive voltages can be optimized.

These and other aspects of the invention are apparent from and will be elucidated with reference to the embodiments described hereinafter.

In the drawings:

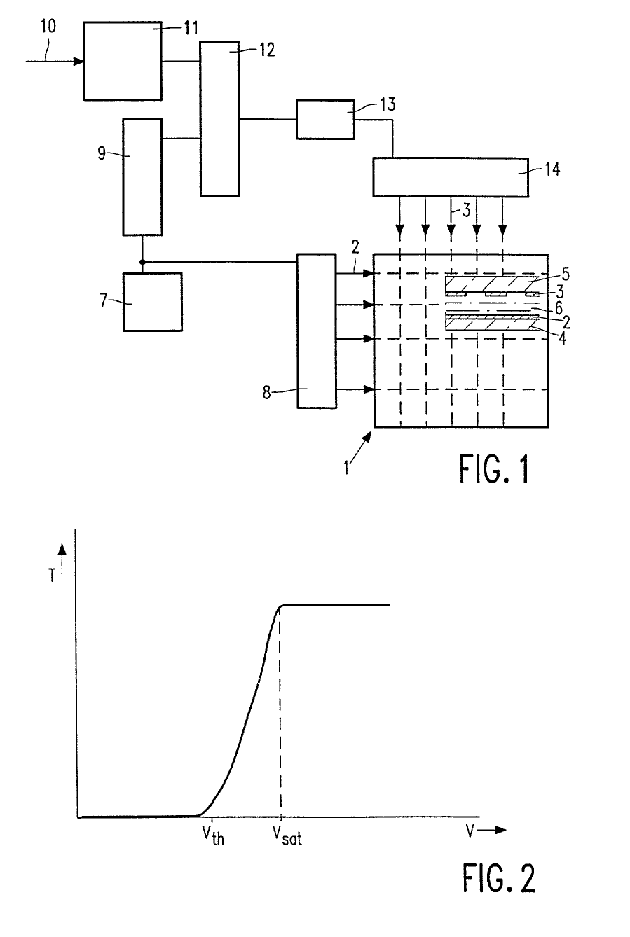

FIG. 1 shows diagrammatically a display device in which the invention is used, and

FIG. 2 shows a transmission/voltage characteristic curve of a liquid crystal material to be used in the device of FIG. 1.

FIG. 1 shows a display device with a matrix 1 of pixels at the area of crossings of N rows 2 and M columns 3 which are provided as row electrodes and column electrodes on facing surfaces of substrates 4, 5, as can be seen in the cross-section shown in the matrix 1. The liquid crystal material 6 is present between the substrates. For the sake of simplicity, other elements, such as orientation layers, polarizers, etc. are omitted in the cross-section.

The device further comprises a row function generator 7 implemented, for example as a ROM, for generating orthogonal signals Fᵢ(t) for driving the rows 2. Similarly as described in said article by Scheffer and Clifton, row vectors are defined during each elementary time interval, which row vectors drive a group of p rows via drive circuits 8. The row vectors are written into a row function register 9.

Information 10 to be displayed is stored in an N×M buffer memory 11 and read as information vectors per elementary unit of time. Signals for the column electrodes 3 are obtained by multiplying the then valid values of the row vector and the information vector by each other during each elementary unit of time and by subsequently adding the p obtained products. The values of the row and column vectors valid during an elementary unit of time are multiplied by comparing them in an array 12 of M exclusive-ORs. The products are added by applying the output signals of the array of exclusive-ORs to the summing logic 13. The signals 16 from the summing logic 13 drive a column drive circuit 14 which provides the columns 3 with voltages Gⱼ(t) with p+1 possible voltage levels. In this case, p rows are always driven simultaneously, in which p<N. The row vectors therefore comprise only p elements, similarly as the information vectors, which leads to an economy of the required hardware such as the number of exclusive-ORs and the size of the summing circuit, as compared with the method in which all rows are driven simultaneously with mutually orthogonal signals (“Active Addressing”).

Generally, it holds for a liquid crystal display device with N rows, whose liquid crystal reacts to the effective value of the voltage, while one row is simultaneously driven with a row selection voltage Vₛ, and the non-selected rows have a voltage equal to zero, and the columns are driven with voltages ±V_{d}, that the effective pixel voltage Vₚ_{_{eff}} is:

$$\begin{matrix}{V}_{{p}_{eff}}^{2} = \frac{{( {V}_{s} \pm {V}_{d} )}^{2} + ( N - 1 ) {V}_{d}^{2}}{N} \\ or & ( 1 ) \\ {V}_{{p}_{eff}}^{2} = \frac{{V}_{s}^{2} + {NV}_{d}^{2} \pm 2 {V}_{s} {V}_{d}}{N} & ( 2 )\end{matrix}$$

For pixels which are on or off, it then holds:

$$\begin{matrix}{V}_{{p}_{on}}^{2} = \frac{{V}_{s}^{2} + {NV}_{d}^{2} + 2 {V}_{s} {V}_{d}}{N} , & ( 3 ) \\ {V}_{{p}_{eff}}^{2} = \frac{{V}_{s}^{2} + {NV}_{d}^{2} \pm 2 {V}_{s} {V}_{d}}{N} \\ so that & ( 4 ) \\ {( \frac{{V}_{{p}_{on}}}{{V}_{{p}_{off}}} )}^{2} = \frac{{V}_{s}^{2} + {NV}_{d}^{2} + 2 {V}_{s} {V}_{d}}{{V}_{s}^{2} + {NV}_{d}^{2} - 2 {V}_{s} {V}_{d}} . & ( 5 )\end{matrix}$$

The voltages are normalized by rendering Vₚ_{_{off}}=1 so that V²ₚ_{_{off}}=1. Filling this in in equation (4) leads to:

V²ₛ+NV²_{d}−2VₛV_{d}=N. (6)

Equation (5) can then be rewritten as:

$${( \frac{{V}_{{p}_{on}}}{{V}_{{p}_{off}}} )}^{2} = \frac{{V}_{s}^{2} + {NV}_{d}^{2} - 2 {V}_{s} {V}_{d} + 4 {V}_{s} {V}_{d}}{{V}_{s}^{2} + {NV}_{d}^{2} - 2 {V}_{s} {V}_{d}} = \frac{N + 4 {V}_{s} {V}_{d}}{N} . \qquad ( 7 )$$

In a display device according to the invention, N≦m, in which m is the number of rows to be maximally multiplexed with a maximum contrast determined by the threshold voltage Vₜₕ and the saturation voltage Vₛₐₜ of the liquid crystal material (FIG. 2). In accordance with the Alt & Pleshko analysis (IEEE Trans. El. Dev., Vol ED-21, No. 2, February 1974, pp. 146-155), this maximum number of rows is equal to:

$$m = {\{ \frac{{( \frac{{V}_{sat}}{{V}_{th}} )}^{2} + 1}{{( \frac{{V}_{sat}}{{V}_{th}} )}^{2} - 1} \}}^{2} . \qquad ( 8 )$$

This can also be written as:

$${( \frac{{V}_{sat}}{{V}_{th}} )}^{2} = \frac{\sqrt{m} + 1}{\sqrt{m} - 1} . \qquad ( 9 )$$

By choosing Vₛₐₜ in equation (7) for V_{P}_{ₒₙ} and Vₜₕ for Vₚ_{_{off}}, instead of maximizing the ratio Vₚ_{ₒₙ}/Vₚ_{_{off}} in accordance with Alt & Pleshko's formula, we find:

$$\begin{matrix}{( \frac{{V}_{{p}_{on}}}{{V}_{{p}_{off}}} )}^{2} = \frac{N + 4 {V}_{s} {V}_{d}}{N} = \frac{\sqrt{m} + 1}{\sqrt{m} - 1} , \\ or & ( 10 ) \\ 2 {V}_{s} {V}_{d} = \frac{N}{\sqrt{m} - 1} , \\ and & ( 11 ) \\ {V}_{d} = \frac{N}{2 {V}_{s} ( \sqrt{m} - 1 )} . & ( 12 )\end{matrix}$$

Substitution of equation (12) in (6) yields:

$${V}_{s}^{2} + \frac{{N}^{3}}{4 {{V}_{s}^{2} ( \sqrt{m} - 1 )}^{2}} - \frac{N}{\sqrt{m} - 1} = N . \qquad ( 13 )$$

This leads to the following equation:

$$\begin{matrix}{V}_{s}^{4} - N ( 1 + \frac{1}{\sqrt{m} - 1} ) {V}_{s}^{2} + \frac{{N}^{3}}{4 {( \sqrt{m} - 1 )}^{2}} = 0 , \\ with the roots & ( 14 ) \\ {V}_{{s}_{1 , 2}}^{2} = \frac{N}{2} [ 1 + \frac{1}{\sqrt{m} - 1} \pm \sqrt{{( 1 + \frac{1}{\sqrt{m} - 1} )}^{2} - N \frac{1}{{( \sqrt{m} - 1 )}^{2}}} ] . & ( 15 )\end{matrix}$$

The value of V_{d} can subsequently be found by filling in the computed value of Vₛ in equation (12).

If N=m, there is only one solution for Vₛ, namely the value which is found for the Alt & Pleshko maximum.

Generally it holds that, for a selection of p rows simultaneously with mutually orthogonal signals Fᵢ(t), the amplitude of the row voltages F is a factor of \sqrt{p} smaller than the value Vₛ which, as computed hereinbefore, is the amplitude for the case of driving one row at a time.

$$F = \frac{{V}_{s}}{\sqrt{p}} . \qquad ( 16 )$$

For the maximal column voltage, the following value is found:

Gₘₐₓ=V_{d}\sqrt{p}. (17)

If p is chosen to be such that the amplitude of row signals F and the maximal column signal Gₘₐₓ are equal, then the required power supply voltage for the drive IC, which is determined by the largest of the two, becomes as small as possible. Equal values for Fₒₚₜ and G_{max,opt} are found when:

$$\begin{matrix}{F}_{opt} = \frac{{V}_{s}}{\sqrt{p}} = {V}_{d} \sqrt{p} = {G}_{max , opt} , \\ so that & ( 18 ) \\ {p}_{opt} = \frac{{V}_{s}}{{V}_{d}} . & ( 19 )\end{matrix}$$

This can be written in a different form as:

$${p}_{opt} = \frac{{V}_{s}^{2}}{{V}_{s} {V}_{d}} . \qquad ( 20 )$$

With the equations (11) and (15), this yields:

$$\begin{matrix}{p}_{opt} = ( \sqrt{m} - 1 ) [ 1 + \frac{1}{\sqrt{m} - 1} \pm \sqrt{{( 1 + \frac{1}{\sqrt{m} - 1} )}^{2} - N \frac{1}{{( \sqrt{m} - 1 )}^{2}}} ] , & ( 21 ) \\ or & \\ {p}_{opt} = \sqrt{m} \pm \sqrt{m - N} . & ( 22 )\end{matrix}$$

By choosing the minus sign in equation (22), the smallest value of pₒₚₜ is obtained. This is favorable because then the number of possible levels p+1 of the column signals is as small as possible, which reduces the hardware of the column portion of the drive IC. Substitution of equation (20) in (11) yields:

$$\begin{matrix}2 \frac{{V}_{s}^{2}}{{p}_{opt}} = \frac{N}{\sqrt{m} - 1} , \\ so that & ( 23 ) \\ \frac{{V}_{s}}{\sqrt{{p}_{opt}}} = \sqrt{\frac{N}{2 ( \sqrt{m} - 1 )}} . & ( 24 )\end{matrix}$$

Filling this in in equation (18) yields

$${F}_{opt} = {G}_{max , opt} = \sqrt{\frac{N}{2 ( \sqrt{m} - 1 )}} . \qquad ( 25 )$$

If pₒₚₜ is not a power of 2, the nearest power of 2 can be chosen for p. In that case, the amplitude of the row signal F and the maximal column voltage Gₘₐₓ are unequal and equal, respectively, to:

$$F = \frac{{V}_{s}}{\sqrt{p}} , \qquad ( 26 )$$

Gₘₐₓ=V_{d}\sqrt{p}. (27)

By making use, according to the invention, of a liquid crystal material with a multiplexibility m, as given by Alt & Pleshko's maximum, which is higher than the real number of rows N to be driven, and for addressing a plurality of rows simultaneously with mutually orthogonal signals, “Multiple-Row Addressing”, it is sufficient to use an optimum row voltage which is maximally a factor

$$\frac{{V}_{s}}{{F}_{opt}} = \sqrt{\frac{\sqrt{N} ( \sqrt{m} - 1 )}{\sqrt{N} - 1}} \qquad ( 28 )$$

lower than when driving one row at a time in accordance with Alt & Pleshko's method and formulas for N rows.

### EXAMPLE 1

For a display with N=64 rows, in which a liquid crystal is used which is 64 times multiplexible (m=64), in which case Alt & Pleshko's maximum is found, this yields: Vₛ=6.047×Vₜₕ, V_{d}=0.756×Vₜₕ, Pₒₚₜ=8, Fₒₚₜ=G_{max,opt}=2.138×Vₜₕ. With Vth=1.4 V, the amplitude of the row voltage would be Vs=8.466 V when driving one row at a time, and that of the column voltage V_{d} would be 1.058 V.

If 8 rows are driven every time with mutually orthogonal signals, the amplitude of the row voltage F will become 2.993 V and that of the maximum column voltage Gₘₐₓ will also become 2.993 V. A drive IC is then sufficient with a power supply voltage V_{B}=2×2.993=5.987 V instead of V_{B}¹=Vₛ+V_{d}=9.525 V, which is the case when driving with one row at a time! For the ratio F/Gₘₐₓ between the row voltages and the maximal column voltages, it holds in this example (where m=m_{eff}): F/Gₘₐₓ=1.

### EXAMPLE 2

The same display with N=64 rows now has a liquid crystal with m=121. Then the formulas based on the invention yield:

Vₛ=3.323×Vₜₕ, V_{d}=0.963×Vₜₕ, pₒₚₜ=3.45, Fₒₚₜ=G_{max,opt}=1.789×V_{th.}

Since p must be an integer, preferably a power of 2 (p=2^{s}), p is chosen to be 4 so that F=1.661×Vₜₕd, Gₘₐₓ=1.926×Vₜₕ. With Vₜₕ=1.4 V, an amplitude of 4.651 V for the row signal Vₛ and 1.348 V for the column signal V_{d} is found when driving one row at a time. (If Alt & Pleshko's formulas were used for N=64 rows, the same values would be found for Vₛ and V_{d} as in example 1.) If 4 rows are driven every time with orthogonal signals, then the amplitude of the row voltage F becomes 2.326 V and the maximum amplitude of the column voltage Gₘₐₓ becomes 2.697 V so that a power supply voltage of 2×2.697=5.393 V is sufficient for the drive IC! Also in this example, it holds that m=m_{eff}. Since p≈pₒₚₜ, a number ≈1 is found for F/Gₘₐₓ, namely 0.862.

### EXAMPLE 3

The same display with N=64 rows and a liquid crystal with m=121 is now driven in such a way as if the maximum multiplexibility is 100, i.e. m_{eff}=100, which means that the characteristic is slightly further driven than exactly between Vₜₕ and Vₛₐₜ. Thus, in this example, N<m_{eff}<m. Now we find: Vₛ=3.771×Vₜₕ, V_{d}=0.943×Vₜₕ, Pₒₚₜ=4, Fₒₚₜ=G_{max,opt}=1.886×Vₜₕ. With Vₜₕ=1.4 V we find an amplitude of 5.280 V for the row signal Vₛ when driving one row at a time and 1.320 V for the column signal V_{d}. (If Alt & Pleshko's formulas were used for N=64 rows, the same values as in example 1 would be found again for Vₛ and V_{d}.) If 4 rows are driven every time with orthogonal signals, then the amplitude of the row voltage F becomes 2.640 V and the maximum amplitude of the column voltage Gₘₐₓ also becomes 2.640 V so that a power supply voltage of 5.280 V for the drive IC is sufficient. F/Gₘₐₓ is 1 again.

### EXAMPLE 4

A display with N=64 rows and a liquid crystal with m=256 yields the following values:

Vₛ=2.138×Vₜₕ, V_{d}=0.998×Vₜₕ, pₒₚₜ=2.14, Fₒₚₜ=G_{max,opt}=1.461×Vₜₕ.

Since p must be an integer, preferably a power of 2 (p=2^{s}), p is chosen to be 2 which leads to F=1.512×Vₜₕ, Gₘₐₓ=1.411×Vₜₕ.

With Vₜₕ=1.4 V, we find an amplitude of 2.994 V for the row signal Vₛ when driving one row at a time and 1.397 V for the column signal V_{d}. (If Alt & Pleshko's formulas were used for N=64 rows, the same values as in example 1 would be found again for Vₛ and V_{d}.) If 2 rows are driven every time with orthogonal signals, then the amplitude of the row voltage F becomes 2.117 V and the maximum amplitude of the column voltage Gₘₐₓ becomes 1.975 V so that a power supply voltage of 2×2.117=4.234 V is sufficient for the drive IC!

### EXAMPLE 5

For a display with N=100 rows, in which a liquid crystal is used which is 100 times multiplexible (m=100), in which case Alt & Pleshko's maximum is found, it holds that:

Vₛ=7.454×Vₜₕ, V_{d}=0.745×Vₜₕ, pₒₚₜ=10, Fₒₚ=G_{max,opt}=2.357×Vₜₕ.

Since p must be an integer, preferably a power of 2 (p=2^{s}), p is chosen to be 8 so that F=2.635×Vₜₕ, Gₘₐₓ=2.108×Vₜₕ. With Vₜₕ=1.4 V, an amplitude of 10.435 V for the row signal Vₛ and 1.044 V for the column signal V_{d} is found when driving one row at a time. If 8 rows are driven every time with orthogonal signals, then the amplitude of the row voltage F becomes 3.689 V and the maximum amplitude of the column voltage Gₘₐₓ becomes 2.951 V so that a power supply voltage of 2×3.7 V=7.4 V is sufficient for the drive IC! The mutual ratio F/Gₘₐₓ is 1.250 in this case.

### EXAMPLE 6

The same display with N=100 rows now has a liquid crystal with m=121. Then the formulas based on the invention yield:

Vₛ=5.665×Vₜₕ, V_{d}=0.883×Vₜₕ, pₒₚₜ=6.42, Fₒₚₜ=G_{max,opt}=2.236×Vₜₕ.

Since p must be an integer, preferably a power of 2 (p=2^{s}), p is chosen to be 8 so that F=2.003×Vₜₕ, Gₘₐₓ=2.497×Vₜₕ. With Vₜₕ=1.4 V, an amplitude of 7.93 V for the row signal Vₛ and 1.236 V for the column signal V_{d} is found when driving one row at a time. (If Alt & Pleshko's formulas were used for N=100 rows, the same values would be found for Vₛ and V_{d} as in example 5.) If 8 rows are driven every time with orthogonal signals, then the amplitude of the row voltage F becomes 2.804 V and the maximum amplitude of the column voltage Gₘₐₓ becomes 3.495 V so that a power supply voltage of 2×3.495=6.990 V is sufficient for the drive IC! The ratio F/Gₘₐₓ is now 0.802, while m=m_{eff}.

In the examples above, a choice has always been made for Pₒₚₜ=√m−√m−N. If Pₒₚₜ=√m+√m−N is chosen, (which is introduced into the formula as from formula (15), then it follows for a display (example 7) with N=64 and m_{eff}=100 that:

Vₛ=7.542×Vₜₕ, V_{d}=0.471×Vₜₕ, Pₒₚₜ=16 and Fₒₚₜ=Gₒₚₜₘₐₓ=1.886×Vₜₕ.

The voltages F,Gₘₐₓ found are identical to those of example 3. However, the number of rows to be driven simultaneously is larger, which requires a more complicated electronic circuit for driving the rows.

In summary, the invention relates to a passive-matrix liquid-crystal display driven by means of “Multiple-Row Addressing”, in which a group of rows is every time driven by mutually orthogonal signals, while the drive voltages are decreased by an optimum choice of the liquid crystal and the number of orthogonal signals.

1. A display device comprising a liquid crystal material between a first substrate provided with row or selection electrodes and a second substrate provided with column or data electrodes, in which overlapping parts of the row and column electrodes define pixels, and drive means for driving the column electrodes in conformity with an image to be displayed, drive means for driving the row electrodes, characterized in that the multiplexibility m of the liquid crystal material is larger than or equal to the number of row electrodes N, and that drive means for driving the row electrodes in the operating state sequentially provide groups of p electrodes with mutually orthogonal signalsthe value of p of the number of rows which is driven simultaneously being an integer which is to be chosen as proximate as possible to the value pₒₚₜ=\sqrt{m_{eff}}±\sqrt{m_{eff}−N}, in which N<m_{eff}<m.

2. A display device as claimed in claim 1, characterized in that the maximum amplitude of a signal to be presented to a column or row electrode is smaller than half the sum of the amplitudes of the column and row signals, defined in accordance with Alt & Pleshko when driving N rows with one row at a time.

3. A display device as claimed in claim 1, characterized in that the maximum amplitude of a signal to be presented to a column or row electrode is smaller than the minimum of half the sum of the amplitudes of the column and row signals required for selecting one row at a time.

4. A display device as claimed in claim 1, characterized in that it holds for the ratio of the amplitudes F of the row electrode voltages and the amplitude Gₘₐₓ of the maximum column voltage that:
0.7<F/Gₘₐₓ<1.3

5. A display device as claimed in claim 1, characterized in that N<m.

6. A display device as claimed in claim 1, characterized in that
pₒₚₜ=\sqrt{m}−\sqrt{m−N}.

7. A display device as claimed in claim 1, characterized in that the chosen value of p is a power of two, or one less.

8. A display device as claimed in claim 1, characterized in that the drive means comprise at least one drive-IC for presenting both row and column voltages.
